(19) United States
(12) Patent Application Publication
(10) Pub. No.: US 2026/0030887 A1
(43) Pub. Date: Jan. 29, 2026

(54) MULTIMODAL ITEM IDENTIFICATION

(71) Applicant: DoorDash, Inc., San Francisco, CA (US)

(72) Inventors: Weiyu Zhou, Bellevue, WA (US); Sarah Olsen, Brooklyn, NY (US); Larry Waldman, San Francisco, CA (US)

(73) Assignee: DoorDash, Inc., San Francisco, CA (US)

(21) Appl. No.: 19/279,855

(22) Filed: Jul. 24, 2025

Related U.S. Application Data
(60) Provisional application No. 63/675,590, filed on Jul. 25, 2024.

(51) Int. Cl. G06V 20/50; G06Q 10/087; G06V 10/70; G06V 20/68; G06V 30/262

(52) U.S. Cl. CPC G06V 20/50; G06Q 10/08741; G06V 10/768; G06V 20/68; G06V 30/262

(57) ABSTRACT

A method includes a method comprising receiving, by a computer, image data of an image of a shelf unit with a plurality of items and a plurality of item tags comprising machine readable codes adjacent to the items. The method also includes identifying, by the computer, an item associated with a shelf tag in the plurality of shelf tags. After identifying the item, performing, by the computer, additional processing with respect to the identified item.

### CROSS-REFERENCE TO RELATED APPLICATIONS

This application is a non-provisional application of and claims priority to U.S. Provisional Application No. 63/675,590, filed on Jul. 25, 2024, which is herein incorporated by reference in its entirety.

### SUMMARY

One embodiment is related to a method comprising: receiving, by a computer, image data of an image of a shelf unit with a plurality of items and a plurality of item tags comprising machine readable codes adjacent to the items; identifying, by the computer, an item associated with an item tag in the plurality of item tags using a multi-modal item identification process; and performing, by the computer, additional processing with respect to the identified item.

Another embodiment is related to a computer comprising: a processor; and a non-transitory computer readable medium comprising, code executable by the processor to cause the computer to perform operations comprising: receiving image data of an image of a shelf unit with a plurality of items and a plurality of item tags comprising machine readable codes adjacent to the items; identifying an item associated with an item tag in the plurality of item tags using a multi-modal item identification process; and performing additional processing with respect to the identified item.

Another embodiment of the invention includes a system comprising: a mobile phone; and a computer in communication with the mobile phone, comprising, a processor, and a non-transitory computer readable medium comprising code, executable by the processor, to perform operations including, receiving image data of an image of a shelf unit with a plurality of items and a plurality of item tags comprising machine readable codes adjacent to the items, identifying an item associated with an item tag in the plurality of item tags using a multi-modal item identification process, and performing additional processing with respect to the identified item, wherein the image data comprises data derived from multiple photographs of the shelf unit taken using the mobile phone.

Further details regarding embodiments of the disclosure can be found in the Detailed Description and the Figures.

### BRIEF DESCRIPTION OF THE DRAWINGS

FIG. 1 shows a block diagram of a system according to embodiments.

FIG. 2 shows a block diagram of components of an analysis computer according to embodiments.

FIG. 3 shows a flowchart illustrating a method according to embodiments.

FIG. 4 shows another flowchart illustrating exemplary methods according to embodiments.

FIG. 5 shows an image of a plurality of overlapping photos of shelves and a planogram corresponding to the plurality of photos.

FIG. 6 shows images of a shelf, items on the shelf, and a photo of an item tag corresponding to the photo.

FIG. 7 shows an image of a shelf with indications of out of stock items.

FIG. 8 shows a diagram of a system according to embodiments.

### DETAILED DESCRIPTION

Prior to discussing embodiments of the disclosure, some terms can be described in further detail.

A “user” may include an individual or a computational device. In some embodiments, a user may be associated with one or more personal accounts and/or mobile devices. In some embodiments, the user may be a cardholder, account holder, or consumer.

A “user device” may be any suitable electronic device that can process and communicate information to other electronic devices. The user device may include a processor, and a computer-readable medium coupled to the processor, the computer-readable medium comprising code, executable by the processor. The user device may also each include an external communication interface for communicating with each other and other entities. Examples of user devices may include a mobile device (e.g., a mobile phone), a laptop or desktop computer, a wearable device (e.g., smartwatch), etc.

“Image data” can include information related to a visible impression obtained by a camera, telescope, microscope, or other device, or displayed on a computer or video screen. Image data can include a plurality of pixels, where each pixel can include data that indicates how that pixel is displayed (e.g., a color value, etc.).

A “shelf unit” can include a surfaces upon which items can be displayed. A shelf unit can include horizontal shelves, gondola shelves, wire rack shelves, etc. A shelf unit can display a plurality of items and item tags that relate to the items.

An “item tag” can include a label that includes information about an item. An item tag can include a machine readable code (e.g., a barcode, a QR code, etc.), a price, SKU codes, and/or other information that describes the related item.

A “barcode” can include a machine-readable code that includes a plurality of bars. A barcode can be in the form of numbers and a pattern of parallel lines of varying widths (e.g., bars). A barcode can correspond to and identify a specific item.

A “map” can include data that has a corresponding relationship to other data. A map can include data related to items and how the items relate to one another on a shelf unit. A map can be a topological graph. In some embodiments, a map can be a planogram.

A “topological graph” can include a representation of a graph in a plane of distinct vertices connected by edges. The distinct vertices in a topological graph may be referred to as “nodes.” Each node may represent specific information for an event or may represent specific information for a profile of an entity or object. The nodes may be related to one another by a set of edges, E. An “edge” can include an unordered pair composed of two nodes as a subset of the graph G=(V, E), where is G is a graph comprising a set V of vertices (nodes) connected by a set of edges E. An edge may be associated with a numerical value, referred to as a “weight,” that may be assigned to the pairwise connection between the two nodes. The edge weight may be identified as a strength of connectivity between two nodes and/or may be related to a cost or distance, as it often represents a quantity that is required to move from one node to the next.

A “planogram” can include diagram that shows how and where specific items can and/or should be placed on shelves. A planogram can indicate items and item locations on a shelf. In some cases, a planogram can indicate a size of an item on a shelf.

The term “node” can include a discrete data point representing specified information. Nodes may be connected to one another in a topological graph by edges, which may be assigned a value known as an edge weight in order to describe the connection strength between the two nodes. For example, a first node may be a data point representing a first item on a shelf unit, and the first node may be connected in a graph to a second node representing a second item on a shelf unit. An edge weight may also be used to express a cost or a distance required to move from one node to the next. For example, a first node may be a data point representing a first position of a first item, and the first node may be connected in a graph to a second node for a second position of a second item. The edge weight may be the distance between the first position and the second position.

A “machine learning model” (ML model) can refer to a software module configured to be run on one or more processors to provide a classification or numerical value of a property of one or more samples. An ML model can include various parameters (e.g., for coefficients, weights, thresholds, functional properties of function, such as activation functions). As examples, an ML model can include at least 10, 100, 1,000, 5,000, 10,000, 50,000, 100,000, or one million parameters. An ML model can be generated using sample data (e.g., training samples) to make predictions on test data. Various number of training samples can be used, e.g., at least 10, 100, 1,000, 5,000, 10,000, 50,000, 100,000, or at least 200,000 training samples. One example is an unsupervised learning model such as hidden Markov model (HMM), clustering (e.g., hierarchical clustering, k-means, mixture models, model-based clustering, density-based spatial clustering of applications with noise (DBSCAN), and OPTICS algorithm), approaches for learning latent variable models such as Expectation-maximization algorithm (EM), method of moments, and blind signal separation techniques (e.g., principal component analysis, independent component analysis, non-negative matrix factorization, singular value decomposition), and anomaly detection (e.g., local outlier factor and isolation forest). Another example type of model is supervised learning that can be used with embodiments of the present disclosure. Example supervised learning models may include different approaches and algorithms including analytical learning, statistical models, artificial neural network (e.g. including convolutional and/or transformer layers) that may have 1-10 layers as examples, recurrent neural network (e.g., long short term memory, LSTM), boosting (meta-algorithm), bootstrap aggregating (bagging) such as random forests, support vector machine (SVM), support vector (SVR), Bayesian statistics, case-based reasoning, decision tree learning, inductive logic programming, linear regression, logistic regression, Gaussian process regression, genetic programming, group method of data handling, kernel estimators, learning automata, learning classifier systems, minimum message length (decision trees, decision graphs, etc.), multilinear subspace learning, naive Bayes classifier, maximum entropy classifier, conditional random field, nearest neighbor algorithm, probably approximately correct learning (PAC) learning, ripple down rules, a knowledge acquisition methodology, symbolic machine learning algorithms, subsymbolic machine learning algorithms, minimum complexity machines (MCM), ordinal classification, data pre-processing, handling imbalanced datasets, statistical relational learning, or Proaftn (a multicriteria classification algorithm), or an ensemble of any of these types. Supervised learning models can be trained in various ways using various cost/loss functions that define the error from the known label (e.g., least squares and absolute difference from known classification) and various optimization techniques, e.g., using backpropagation, steepest descent, conjugate gradient, and Newton and quasi-Newton techniques.

A “deep neural network (DNN)” may be a neural network in which there are multiple layers between an input and an output. Each layer of the deep neural network may represent a mathematical manipulation used to turn the input into the output. In particular, a “recurrent neural network (RNN)” may be a deep neural network in which data can move forward and backward between layers of the neural network.

A “model database” may include a database that can store machine learning models. Machine learning models can be stored in a model database in a variety of forms, such as collections of parameters or other values defining the machine learning model. Models in a model database may be stored in association with keywords that communicate some aspect of the model. For example, a model used to evaluate news articles may be stored in a model database in association with the keywords “news,” “propaganda,” and “information.” A computer can access a model database and retrieve models from the model database, modify models in the model database, delete models from the model database, or add new models to the model database.

A “feature vector” may include a set of measurable properties (or “features”) that represent some object or entity. A feature vector can include collections of data represented digitally in an array or vector structure. A feature vector can also include collections of data that can be represented as a mathematical vector, on which vector operations such as the scalar product can be performed. A feature vector can be determined or generated from input data. A feature vector can be used as the input to a machine learning model, such that the machine learning model produces some output or classification. The construction of a feature vector can be accomplished in a variety of ways, based on the nature of the input data. For example, for a machine learning classifier that classifies words as correctly spelled or incorrectly spelled, a feature vector corresponding to a word such as “LOVE” could be represented as the vector (12, 15, 22, 5), corresponding to the alphabetical index of each letter in the input data word. For a more complex “input,” such as a human entity, an exemplary feature vector could include features such as the human's age, height, weight, a quantitative representation of relative happiness, etc. Feature vectors can be represented and stored electronically in a feature store. Further, a feature vector can be normalized (i.e., be made to have unit magnitude). As an example, the feature vector (12, 15, 22, 5) corresponding to “LOVE” could be normalized to approximately (0.40, 0.51, 0.74, 0.17).

A “processor” may include a device that processes something. In some embodiments, a processor can include any suitable data computation device or devices. A processor may comprise one or more microprocessors working together to accomplish a desired function. The processor may include a CPU comprising at least one high-speed data processor adequate to execute program components for executing user and/or system-generated requests. The CPU may be a microprocessor such as AMD's Athlon, Duron, and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may comprise one or more computational apparatuses and may use any of a variety of computing structures, arrangements, and compilations for servicing the requests from one or more client computers.

Service providers such as merchants need to scan items on their shelves for inventory purposes to maintain accurate, real-time records of their stock levels, which is desirable for the effective management of their operations. Regular scanning allows merchants to identify discrepancies between the physical inventory and the records in their inventory management system, helping to detect issues such as theft, loss, misplacement, or administrative errors. Accurate inventory data enables merchants to optimize their supply chain by ensuring that popular or high-demand items are always available, reducing the risk of lost sales due to stockouts or overstocking. In addition, service providers and other entities such as delivery service providers may need to know if an item is in stock or out of stock so that they know whether or not such goods can be provided to users. It is more difficult for entities such as delivery services to determine whether or not items are or are not present in a merchant store and the quantities of such items, since they do not have ready access to the inventory data for that merchant store.

In some cases, transporters can obtain items at service provider locations based on orders provided by end users. The transporters can deliver the items to the end users. However, the end users can select to receive items in a delivery application that are not available at the service providers (e.g., the items may be no longer available). If this occurs, it can be difficult and time consuming for the transporter to locate the item or search for a similar item at the service provider or another service provider.

Currently, to determine if an item is present on a shelf at a service provider, a person can use a handheld barcode scanner to scan individual item tags on a shelf to identify the items of the shelf. The person can visually confirm the presence or non-presence of the items associated with the item tags. Barcode scanning of item tags is slow since each individual tag on a shelf or in a store needs to be scanned. Further, persons that are not employees of a store is typically not given permission to spend hours scanning item tags to determine the availability of items in the store.

Computer vision techniques can be used to scan the items on the shelves. In some cases, an image detection model can be trained on a data set to identify the SKUs (stock keeping units) from the store shelf images. However, the accuracy of using only the computer vision approach is low. In some cases, the accuracy of identifying items on a shelf using computer vision can be at best 95% under some circumstances, while it can be at best about 75% under other circumstances.

Embodiments of the disclosure address this problem and other problems individually and collectively.

Embodiments of the invention can include methods that can leverage different sources of data, including the use of computer vision techniques, to build an ensemble model that can quickly and accurately identify the items on one or more shelf units at a service provider location (e.g., a grocery store).

Embodiments of the invention can allow user devices to capture images of shelf units with items. An analysis computer can analyze the captured images. In embodiments of the invention, an analysis computer can identify the items on the shelf unit(s) using a multi-modal identification process. The multi-modal identification process can identify an item on a shelf unit by analyzing data using at least two, or preferably all of the following: a machine readable code on an item tag corresponding to the item; text on the item tag corresponding to the item (e.g., identifying the text on an item tag using optical character recognition or OCR, such as the process described in U.S. patent application Ser. No. 19/250,782, filed on Sep. 26, 2025, which is herein incorporated by reference); product text on the item (e.g., identifying the text on an item using OCR); computer vision identification of the item; and historical data associated with of the item on the shelf unit (e.g., determining an identification of an item using historical data regarding the item at the location on the shelf using, e.g., a planogram such those that are described in U.S. Application No. 63/675,646, filed on Jul. 24, 2024, and U.S. application Ser. No. 19/082,577, filed on Mar. 28, 2024).

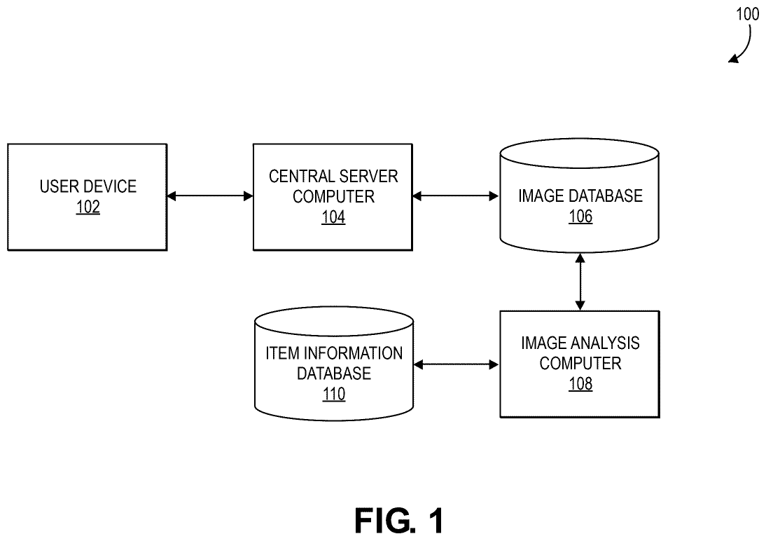

FIG. 1 shows a system 100 according to embodiments of the disclosure. The system 100 comprises a user device 102, a server computer 104, an image database 106, an image analysis computer 108, and an item information database 110.

The user device 102 can be in operative communication with the server computer 104. The server computer 104 can be in operative communication with the image database 106 and the item information database 110. The image analysis computer 108 can be in operative communication with the image database 106 and the item information database 110.

For simplicity of illustration, a certain number of components are shown in FIG. 1. It is understood, however, that embodiments of the invention may include more than one of each component. In addition, some embodiments of the invention may include fewer than or greater than all of the components shown in FIG. 1.

Messages between devices in the system 100 illustrated in FIG. 1 can be transmitted using a secure communications protocols such as, but not limited to, File Transfer Protocol (FTP); HyperText Transfer Protocol (HTTP); Secure Hypertext Transfer Protocol (HTTPS), SSL, and/or the like. The communications network may include any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. The communications network can use any suitable communications protocol to generate one or more secure communication channels. A communications channel may, in some instances, comprise a secure communication channel, which may be established in any known manner, such as through the use of mutual authentication and a session key, and establishment of a Secure Socket Layer (SSL) session.

The user device 102 can include an end user device operated by a user, such as a smartphone, a tablet, a smart wearable device, etc. The user device 102 can include a camera that can capture image data of an image. The user device 102 can provide image data for one or more images to the server computer 104.

For example, the user device 102 can capture image data of an image of a shelf unit with specific items and item tags comprising machine readable codes adjacent to the specific items. The user device 102 can provide the image data to the server computer 104. In some embodiments, the user device 102 can capture a plurality of image data and can provide the plurality of image data to the server computer 104.

The server computer 104 can be a central server computer 902 such as the one illustrated in FIG. 9. The server computer 104 can communicate with a plurality of user devices (e.g., including the user device 102) to obtain image data. The server computer 104 can store received image data into the image database 106.

The image database 106 can store image data. The image database 106 can store image data in association with service provider identifiers, user device identifiers, shelf unit identifiers, or any other identifiers that can link the image data to devices involved in the capturing of the image data, to the location of the image data, and/or to information related to the contents of the image data. For example, the image database 106 can store information that relates the image data other data. For example, the image database 106 can store the image data in association with service provider locations, service provider identifiers, service provider location identifiers, aisle identifiers, user device orientation data, image metadata, and/or other data.

The image analysis computer 108 can be a laptop computer, a desktop computer, a server computer, etc. The image analysis computer 108 can be configured to process image data. The image analysis computer 108 can obtain image data from the image database 106. The image analysis computer 108 can analyze the image data.

The image analysis computer 108 can analyze the image data derived from images of one or more shelf units to accurately identify the presence and/or the quantity of items on a shelf unit.

The image database 106 and the item information database 110 can include any suitable databases. The databases may be conventional, fault tolerant, relational, scalable, secure databases such as those commercially available from Oracle™ or Sybase™.

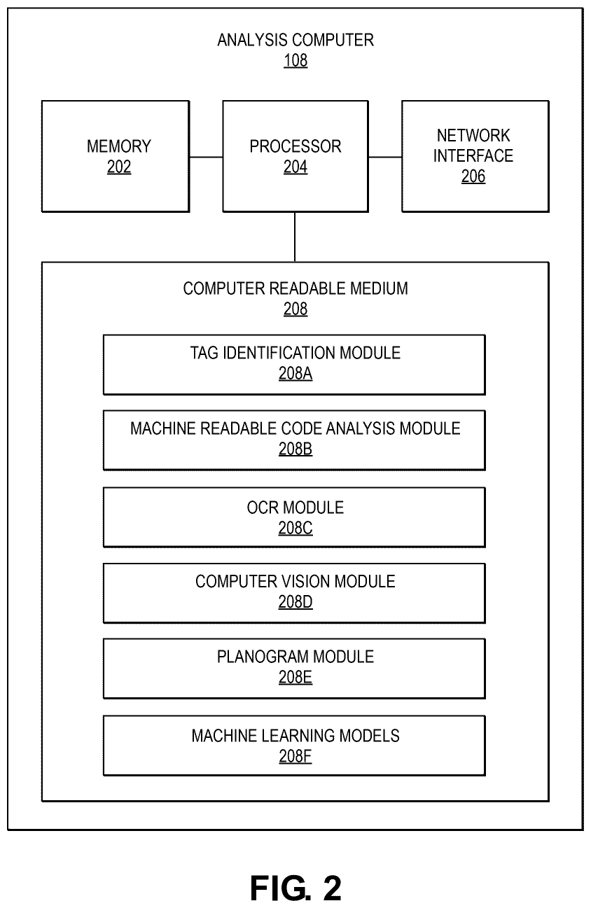

FIG. 2 shows a block diagram of an exemplary analysis computer 108 according to embodiments. The analysis computer 108 may comprise a processor 204. The processor 204 may be coupled to a memory 202, a network interface 206, and a computer readable medium 208.

The memory 202 can be used to store data and code. For example, the memory 202 can store machine learning model training data, machine learning model weights, image data, barcode data, item data, image data, etc. The memory 202 may be coupled to the processor 204 internally or externally (e.g., cloud based data storage), and may comprise any combination of volatile and/or non-volatile memory, such as RAM, DRAM, ROM, flash, or any other suitable memory device.

The computer readable medium 208 may comprise code, executable by the processor 204, for performing a method comprising: receiving, by a computer, image data of an image of a shelf unit with a plurality of items and a plurality of item tags comprising machine readable codes adjacent to the items; identifying, by the computer, an item in the plurality of items using a multi-modal item identification process; and performing, by the computer, additional processing with respect to the identified item.

The computer readable medium 208 may a tag identification module 208A, a machine readable code analysis module 208B, an OCR module 208C, a computer vision module 208D, a planogram module 208E, and machine learning models 208F.

The tag identification module 208A, in conjunction with the processor 204, can identify tags such as shelf tags for items in images of shelf units with tags and items.

The machine readable code analysis module 208B, in conjunction with the processor 204, can analyze machine readable codes such as barcodes to decode them.

The OCR module 208C in conjunction with the processor 204, can perform optical character recognition of text.

The computer vision module 208D, in conjunction with the processor 204, can perform computer vision processing of images to identify objects in images.

The planogram module 208E, in conjunction with the processor 204 can generate a planogram, update a planogram, and/or analyze a planogram.

The machine learning models 208F can include one or more machine learning models that can process data.

The network interface 206 may include an interface that can allow the analysis computer 108 to communicate with external computers. The network interface 206 may enable the analysis computer 108 to communicate data to and from another device (e.g., the database 106, etc.). Some examples of the network interface 206 may include a modem, a physical network interface (such as an Ethernet card or other Network Interface Card (NIC)), a virtual network interface, a communications port, a Personal Computer Memory Card International Association (PCMCIA) slot and card, or the like. The wireless protocols enabled by the network interface 206 may include Wi-Fi™. Data transferred via the network interface 206 may be in the form of signals which may be electrical, electromagnetic, optical, or any other signal capable of being received by the external communications interface (collectively referred to as “electronic signals” or “electronic messages”). These electronic messages that may comprise data or instructions may be provided between the network interface 206 and other devices via a communications path or channel. As noted above, any suitable communication path or channel may be used such as, for instance, a wire or cable, fiber optics, a telephone line, a cellular link, a radio frequency (RF) link, a WAN or LAN network, the Internet, or any other suitable medium.

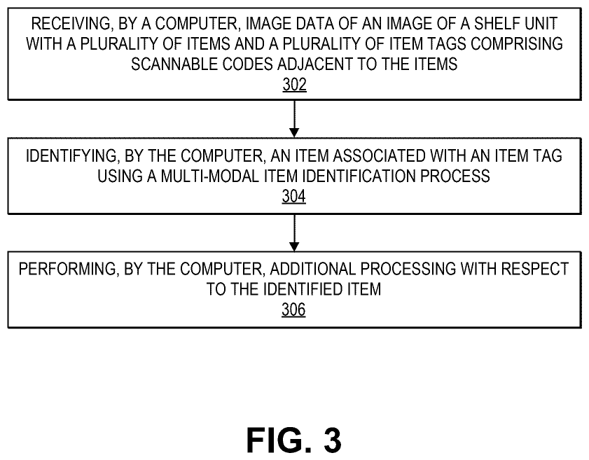

FIG. 3 shows a flowchart of a multimodal item identification method using a computer such as the analysis computer 108 according to embodiments. The method illustrated in reference to FIG. 3 will be described in the context of a user, who is a transporter, obtaining image data at a service provider location using the user device 102. For example, the transporter may be instructed via the user device 102 to proceed to a location in an aisle in a merchant store and take a picture of a shelf unit. The user device 102 provides the image data from the picture to the server computer 104 that stores the image data into the database 106. The analysis computer 108 can obtain the image data and perform the method.

In step 302, the computer receives image data of an image of a shelf unit with a plurality of items and a plurality of item tags (e.g., shelf tags) comprising machine readable codes adjacent to the items from a user device or from a database.

In step 304, the computer identifies an item associated with an item tag using a multi-modal item identification process. The item may or may not be present on the shelf unit. For example, if there is no item on the shelf corresponding to the item tag, then the item that is supposed to be proximate to the item tag is likely out of stock. On the other hand, if the item is present on the shelf unit, then it is in stock.

In some embodiments, the multi-modal item identification process comprises two or more (e.g., preferably all) of the following: a first process of decoding a machine readable code on an item tag corresponding to the item to identify the item; a second process of performing an optical character recognition process on text on the item tag corresponding to the item to identify the item; a third process of performing an optical character recognition process on text on the item to identify the item; a fourth process performing a computer vision identification process on the item to identify the item; and a fifth process of using historical data associated with a location of the item on the shelf unit to identify the item. In some embodiments, a confidence level can be assigned to each of the above processes or the outputs from the above processes when making a final item identification. In some embodiments, the multi-modal item identification process further comprises weighting results of the first, second, third, fourth, and fifth processes, and identifying the item based on the weighted first, second, third, fourth, and fifth process results.

As an illustration, an image of a shelf unit with a number of food items and corresponding item tags (e.g., shelf tags) in a grocery store may be taken by a user device such as a mobile phone. Image data for the image may be transmitted to a server computer, which may further analyze the image. The server computer can attempt to identify an item tag and an item in the image. The server computer can attempt to determine the identity of the item using text on the item tag and the text on the item using an OCR process. In this example, only part of the text of an item tag may be recognizable with OCR, and only part of the text on an item may be recognizable with OCR. Although neither step can identify the item by itself, the combination of the item recognition steps can be used to determine the item. For example, the letters “Cheer” may be read on an item tag and the letters “eerios®” may be read on the item corresponding to that item tag. Combining the two readings, a computer (e.g., using a machine learning algorithm) can determine that the item is likely “Cheerios®.”

In some embodiments, the server computer can use the various individual item identification processes and can assign a confidence level to each one. The confidence levels can be determined by a server computer using historical data considering factors such as the clarity of the image, the number of reasonable alternative items to a candidate identified item, etc. The confidence level of each item identification process can be considered to make a final determination as to the identity of the item. In another example, the server computer can attempt to identify the item by attempting to decode a machine readable code on the item tag. The decoding attempt may identify the item as “product A.” The server computer may determine that the confidence level of this machine readable code identification process is 90% accurate. The server computer can also attempt to identify the item using a machine vision process. The output from the machine vision process may also be “product A.” The server computer may determine that the confidence level of this identification using machine vision is 60% accurate. Together, the overall confidence level of the multi-modal item identification process can be 95% accurate, which is much better than using any one single item identification process by itself. In another example, the server computer may decode a barcode on an item tag on a shelf unit and may determine that the item is “product A” and the confidence level of this result may be 80%. The server computer may also perform an OCR process on the text on the packaging of the item and may determine that the item is “product A.” and the confidence level of this result may be 60%. The server computer may also perform an OCR process on the text of the item tag and may determine that the item is “product A.” The server computer may further use machine vision to determine that the item is “product B” and confidence level of this result may be 60%. The server computer may also obtain historical data from a planogram which may indicate that the approximate location of the shelf tag historically corresponded to “product A” and the confidence level of this result may be 75%. Considering the confidence levels of each of the item determination processes, and considering that four of the item identification processes identified the item as “product A” and one identified the item as “product B,” the server computer can conclude that the item is “product A.”

In step 306, the computer performs additional processing with respect to the identified item. Additional processing can include, but is not limited to, automatically adjusting availability or item quantity indicators in a database or on a server computer, alerting personnel at a service provider if an item tag does not correspond to an item on a shelf unit, auditing of existing historical data of items on shelf units, automatically ordering items that are out of stock or in low stock, etc.

The method of FIG. 3 can be repeated many times for many shelf units, for many aisles at a service provider, and for many service providers. Thus, in some embodiments, the method can include receiving, by the computer from a user device, a plurality of images of multiple shelf units in a service provider location, each of the images in the plurality of images comprising item tags associated with items. The method can also include performing, by the computer, the multi-modal item identification process for all item tags in all images to identify items associated with the item tags, and then performing, by the computer, further additional processing based on the identified items.

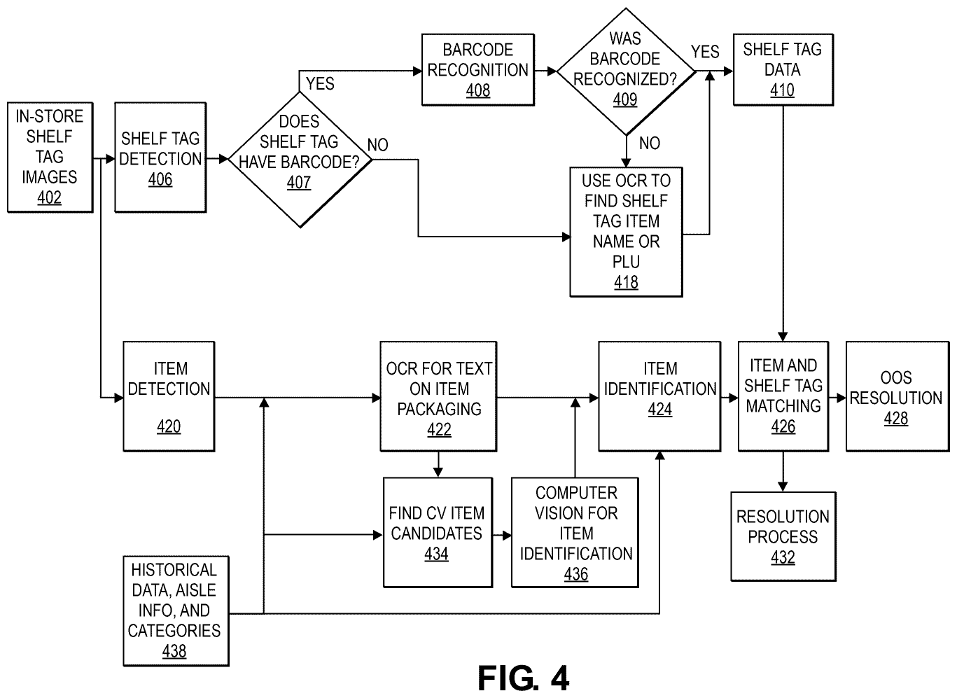

FIG. 4 shows a flowchart illustrating more specific details of embodiments of the invention.

At step 402, the computer obtains one or more images. The images may each include item tag images and item images from images of shelf units. The computer can obtain the images (or image data thereof) from a user device or from a database. For example, a user (e.g., an employee of a service provider, a transporter, etc.) can use a user device (e.g., a mobile phone, tablet computer, etc.) to take one or more images (e.g., still pictures or videos) of one or more shelf units in a service provider location. The one or more images can be provided to a server computer, where the one or more images can be analyzed. The images can be in, for example, PNG, TIFF, PDF, GIF, JPEG, WebP, or MBP file formats.

In some embodiments, the computer can analyze the image using an appropriate machine learning model and decide if the images are associated with a produce aisle. If the answer “yes,” then a produce identification flow is performed. If the answer is “no,” then the process proceeds to step 406 and step 420. In step 406, a shelf tag detection process is performed. In step 420, an item detection process is performed. The item detection process in step 420 may not be performed if there is no item on the shelf corresponding to the shelf tag.

In the shelf tag detection process in step 406, one or more computer vision learning models can be used to identify item tags in an image and then identify machine readable codes in the item tags.

The one or more computer vision machine learning models can be designed to evaluate visual data based on features and contextual information identified during training of the computer vision machine learning model. This training can allow the computer vision machine learning model to interpret images as well as video (e.g., which can be a sequence of images) and apply those interpretations to predictive or decision making tasks.

The one or more computer vision machine learning models can include a convolutional neural network. Convolutional neural networks can be neural networks with a multi-layered architecture that are used to gradually reduce data and calculations to the most relevant set. This most relevant set is then compared against known data (e.g., such as a label) to identify or classify the data input.

When an image is processed by the computer vision machine learning model, each base color used in the image (e.g., red, green, and blue) can represented as a matrix of values. These values are evaluated and condensed into 3D tensors (e.g., in the case of color images), which can be collections of stacks of feature maps tied to a section of the image. These tensors can be created by passing the image through a series of convolutional layers and pooling layers, which are used to extract the most relevant data from an image segment and condense it into a smaller, representative matrix. This process can be repeated numerous times, which can depend on the number of convolutional layers in the architecture. The final features extracted by the convolutional process are sent to a fully connected layer, which can generate predictions.

Computer vision techniques can utilize two different types of object detection: two-step object detection and one-step object detection.

For two-step object detection, the first step can utilize a region proposal network (RPN), which can provide a number of candidate regions that may contain important objects in the image data. The second step can include passing region proposals to a neural classification architecture, commonly a region-based convolutional neural network (RCNN) based hierarchical grouping algorithm, or region of interest (ROI) pooling in a fast RCNN. These approaches are provided for the tradeoff of increased accuracy, but decreased speed.

One-step object detection can be utilized for real-time object detection. One-step object detection architectures can process image data faster than two-step object detection architectures. One-step object detection architectures can include you only look once (YOLO), single shot multibox detector (SSD), and RetinaNet. The one-step object detection architectures combine the detection and classification steps by regressing bounding box predictions. Each determined bounding box can be represented with a few coordinates, making it easier to combine the detection and classification step and speed up processing. The computer vision machine learning model can utilize one-step object detection.

If the shelf tag detection process is performed, in step 407, a determination is made as to whether the shelf tag has a machine readable code such as a barcode.

If the answer to step 407 is “yes,” then in step 408, a machine readable code recognition process is performed. The machine readable code recognition process can use a machine learning model or barcode decoding software. In some embodiments, specific tag detection and image processing can be used to improve the readability of machine readable codes in items tags. Such techniques are described in U.S. Non-Provisional application Ser. No. 19/250,782, filed on Jun. 26, 2025, filed on Mar. 27, 2025, which is herein incorporated in its entirety by reference.

In step 409, a determination is made as to whether the machine readable code was recognized. If the answer is “no,” then the process proceeds to step 418.

If the answer to step 407 is “no,” then in step 418, an OCR process is used to determine the name of the item or PLU (price look up) code on the shelf tag.

If the answer to step 409 is “yes,” then the process proceeds from steps 409 and 418 to step 410 where shelf tag data are obtained. If the barcode was recognizable and decodable, then the identity of the item can be determined. The computer may obtain the name of the item from the decoded barcode data, which may reside in a database or memory accessible to the computer. If the text or PLU are recognizable using the OCR process, then the computer may identify the item. If the PLU is identified, then the computer may obtain the item name from a database linking PLUs and item names.

In the item detection process in step 420, an OCR process can also be performed on the text on the item's packaging in step 422. The OCR process may identify an item name, and the process may proceed to step 424.

The output of step 422 can also be used to determine a list of computer vision candidates in step 434. The computer vision item candidates can also be determined using historical data and aisle information (from step 438). In some embodiments, the historical data and aisle information can be in the form of a planogram. The planogram can be a spatial map of where items would be on a shelf unit relative to each other. Thus, if the item and item tag currently being analyzed is at a particular position on a shelf unit (e.g., the top middle), then candidate items in that area of the shelf unit can be retrieved by a server computer to determine matching candidate items for the one being analyzed. For example, image may be of a shelf containing cereal boxes. The OCR process in step 422 could scan the text on the package and could identify the lettering “Fruit Loops®.” This output could be combined with possible item candidates from historical data to form a candidate set of items. The candidate set of items can be used in conjunction with the computer vision process in step 436 to identify the item associated with the tag.

In step 436, a computer vision process can also be performed to identify the item. The computer vision process can use a machine learning model to identify the item. For example, the machine learning model may identify items based on features of items including the form of the items' packaging (e.g., box, plastic container, etc.), the characteristics (color, lettering, appearance, etc.) of labels on the items, identification or the other items near the item being analyzed, the size of the items, etc., and may be trained on such features. The item identification obtained by the computer vision process may be compared to the computer vision item candidates in 434 to produce a refined item identification.

The output from steps 422 and 436 can be used to identify SKUs (stock keeping units) associated with the item, and the item may be consequently identified in the item identification in step 424.

The output of steps 410 (from the shelf tag detection flow in step 406) and 424 (from the item detection process in step 420) can be provided to an item and shelf tag matching process in step 426. The item and shelf tag matching process can be a heuristic based arbitration with the following inputs for an item/shelf tag pair: barcode data; OCR data; CV (computer vision) data; and historical data. The historical data can have timestamps associated with them (e.g., timestamps associated with dates when planograms were generated). Weights can be provided to teach of these outputs to arrive at a final item identification for an item that is associated with the analyzed item tag.

The output from step 426 can relate to identification resolution process 432 or a final identification for the item being analyzed. Once the item being analyzed is identified, additional processing can be performed. Additional processing can include, but is not limited to, automatically adjusting availability or item quantity indicators in a database or on a server computer, alerting personnel at a service provider if an item tag does not correspond to an item on a shelf unit, auditing of existing historical data of items on shelf units, automatically ordering out of stock items or items in low amounts, etc.

In some cases, if there was no item on the shelf where the item tag was located and only the shelf tag detection flow in step 406 branch of the method is performed, then an OOS (out of stock) process and planogram update process can be performed at step 428. Long term and short term out of stock detection processes are described in further detail in U.S. patent application Ser. No. 19/082,639, filed on Mar. 18, 2025, and U.S. patent application Ser. No. 19/082,577, filed on Mar. 18, 2025, which are herein incorporated by reference in their entirety for all purposes.

For the identification resolution process 432, on a per image basis, the following inputs, which may include shelf tag data, item image data, and historical data can be provided.

Inputs for shelf tag data may include barcode data (98+% precision and 80-90% recall), OCR data (70-80% precision and 80-90% recall or can give a list of possible data), confidence levels, and a location of a bounding box.

Inputs for item image data may include OCR data (85-95% precision and 70-80% recall or can give a list of possible data), image search data (85-95% precision and 80-90% recall), confidence levels, and location of a bounding box.

Historical data may include previously resolved SKU (stock keeping units) or other item identifiers such as names, PLUs, etc., dates that such data were obtained, and confidence levels.

A number of outputs can be provided from the item identification process. For example, a planogram can be created using items identified using the item identification process. The planogram can include: the resolved SKU—Final resolved SKU after the arbitration; a last seen date—when the item was last seen in the scan; a stock level—whether the item is out of stock; an item relative position—an item location in relation to the shelf tag; sources—a list of sources for item signals; a type—source type e.g., barcode; a date—date of the signal event; and extra item information such as pricing and details.

Logging and subsequent pipelines can include building a dataset with confident matches, adding new items can be added to an enrollment pipeline, updating the planogram for a current aisle, and logging for conflicting matchings where there is no confident resolution. Also, using above information, information about whether a specific item is or is not present on a shelf unit, and the quantities of present items, can be used to update Websites and applications, in real time, which show such items for sale.

With the inputs listed above, all the data can be aggregated together to arbitrate the item identification data and out of stock information. The computer can use a weighted heuristic algorithmic approach to determine the SKU identification. The computer can calculate a score for each possible SKU from signal type with weight, date, and signal confidence score. For conflicting shelf tag and item information, the computer can also identify item misplacement instances.

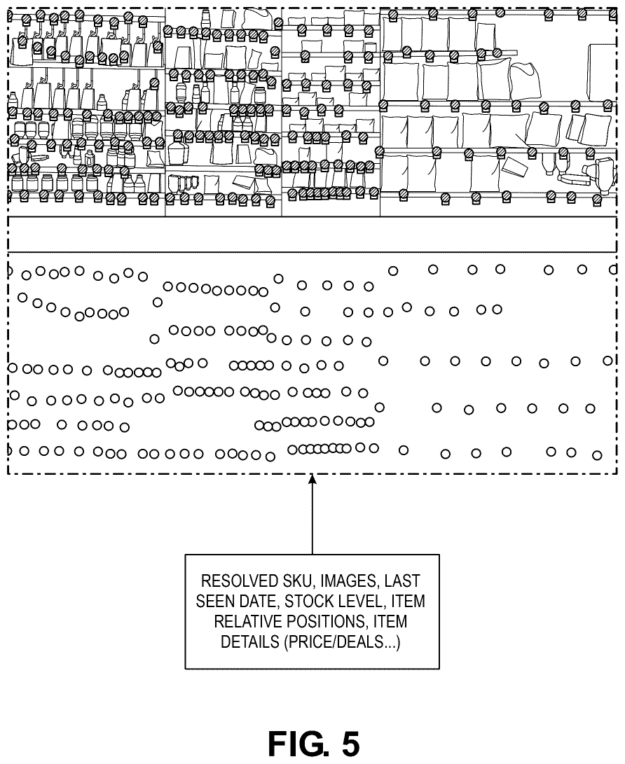

An example of a planogram generated from the shelf tag locations in a photograph is shown in FIG. 5. For a given item, it can include data regarding a resolved SKU (stock keeping unit), images, last seen date, item relative position, and item details (e.g., price, etc.). Such planograms can be built and updated using the methods according to embodiments of the invention.

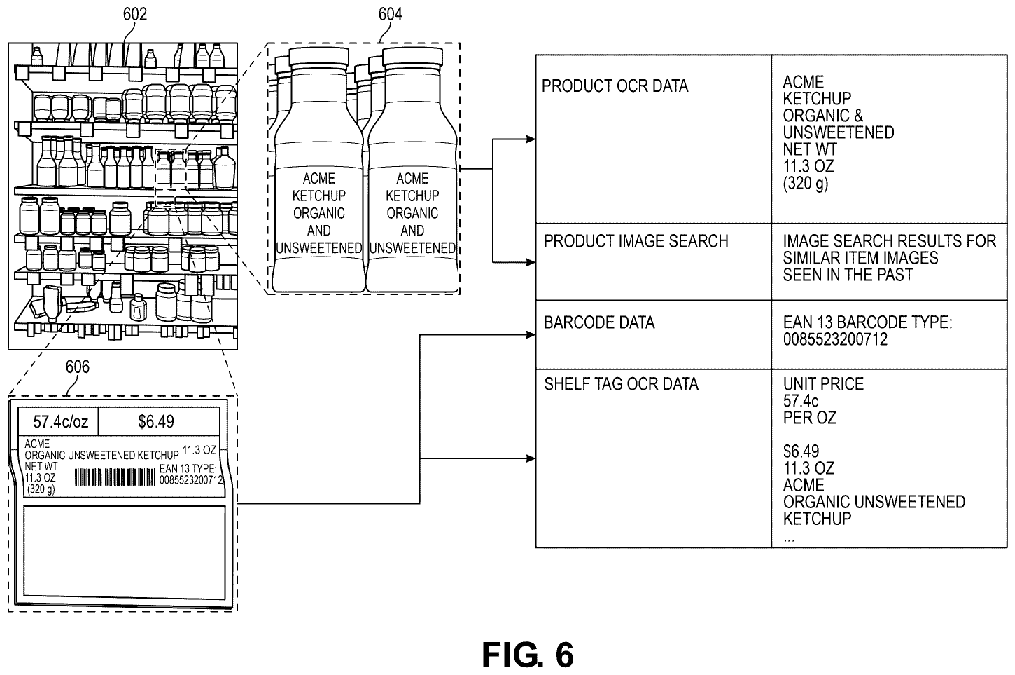

FIG. 6 shows images of a shelf unit 602, items 604 on the shelf unit 602, and a photo of an item tag 606 corresponding to the photo. As shown, the image of the shelf unit 602 shows a number of items and item tags corresponding to those items. A first bounding box corresponds to items of the same type (e.g., ketchup by Primal Kitchen®) and a second bounding box corresponding to the corresponding item tag 606. As shown, the barcode data and shelf OCR data can be determined from the item tag 606. Item OCR data and item image search data may be obtained using images of the items 604.

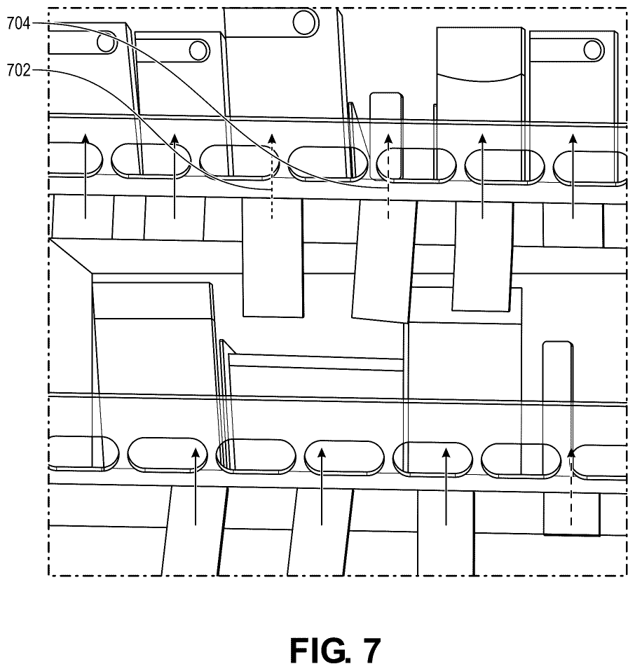

After the computer has identified the shelf tags and the items on the shelf, the computer can try to find the exact SKU matches using the following strategy. After running the above-described processes, the computer can obtain a list of shelf tag locations and a list of item locations. Then, the computer can find the exact matches of the shelf tags and build a vector map. Referring to FIG. 7, the vector map can include a vectors from the matched shelf tag (e.g., 702) to the items shown by the arrows in FIG. 7). For every unpaired shelf tag, the computer can find its neighboring vectors and calculate the median vector. Then, the computer can add the vector to the shelf tag location and the computer will get the approximate item location. If there is an item present, the computer can consider it as a match as shown by 702. If an item is not present, the computer can consider it as an out of stock item as shown by 704. Items without shelf tags can be treated as additional in stock signals.

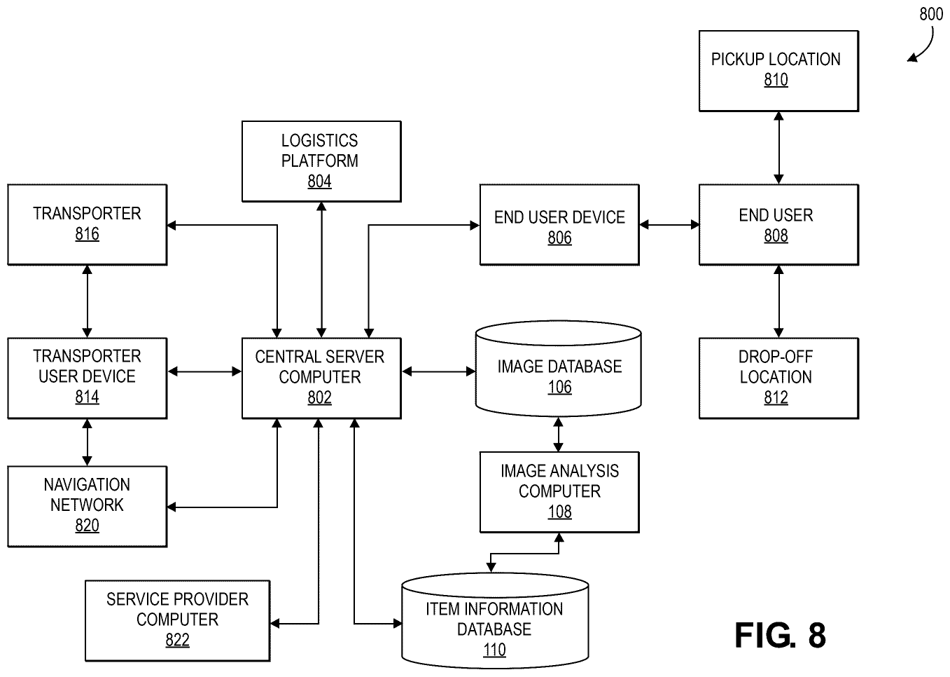

FIG. 8 shows a system 800 according to embodiments of the disclosure. The system in FIG. 8 can be used to coordinate and facilitate the delivery of items from a service providers (e.g., restaurants, grocery stores, etc.) to end users. When items are delivered to end users, transporters can take pictures of shelves stocked with items as described above. Since transporters frequently visit service providers with such stocked items, they can regularly take images of the shelves (e.g., many times per day). As a result, up to date planograms and the availability of items can be updated on a frequent basis (e.g., once per hour or once per day). This was not possible in prior systems of inventory management.

Stated differently, the system 800 shows a system and components used to route transporters to deliver food from service providers or service providers to end users. In some embodiments, the transporters may be requested to retrieve one or more items from a service provider such as a grocery store. While in the grocery store, the transporter may use a transporter user device to take pictures of grocery store shelves while they are picking up items. Over time, many transporters can perform this task, and the central server computer 902 can perform the above-described processing and can update planograms, and item availability indicators, etc. so that the items being offered for delivery are as current as possible. Prior systems were not able to provide such up to date information to end users.

The system of FIG. 8 includes a central server computer 802, a logistics platform 804, an end user device 806, an end user 808, a pickup location 810, a drop-off location 812, a transporter user device 814, a transporter 816, a navigation network 820, a service provider computer 822, the image database 106, the image analysis computer 108, and the item information database 110.

The central server computer 802 can be in operative communication with the logistics platform 804, the end user device 806, the transporter user device 814, the navigation network 820, the service provider computer 822, the image database 106, and the item information database 110. The transporter user device 814 can be in operative communication with the navigation network 820. The image database 106 can be in operative communication with the image analysis computer 108, which can be in operative communication with the item information database 110.

For simplicity of illustration, a certain number of components are shown in FIG. 8. It is understood, however, that embodiments of the invention may include more than one of each component. In addition, some embodiments of the invention may include fewer than or greater than all of the components shown in FIG. 8. For example, although FIG. 8 shows one transporter 816, there can be two, three, or more transporters, transporter user devices, etc.

Messages between the devices and the computers in the system 800 in FIG. 8 can be transmitted using a secure communications protocols as described herein.

The central server computer 802 can be the server computer 104. The central server computer 802 can include a computer that can facilitate in the fulfillment of fulfillment requests received from the end user device 806. For example, the central server computer 802 can identify the transporter 816 (from among many candidate transporters) operating the transporter user device 814 as being suitable for satisfying the fulfillment request. The central server computer 802 can identify the transporter user device 814 that can satisfy the fulfillment request based on any suitable criteria (e.g., transporter location, service provider location, end user destination, end user location, transporter mode of transportation, etc.).

The central server computer 802 can receive data relating to a delivery order of items from the service provider computer 822 to the end user 808 at the drop-off location 812. The central server computer 802 can determine a route for delivery of the delivery order. The central server computer 802 can present the routes to a plurality of transporter user devices and/or transporters. The central server computer 802 can receive acceptances from the transporter 816 that will deliver the items from the pickup location 810 to the drop-off location 812.

The central server computer 802 can receive image data from user devices. For example, the central server computer 802 can receive image data from the transporter user device 814. The central server computer 802 can also receive image data from the end user device 806. The central server computer 802 can store the image data into the database 124.

The central server computer 802 can maintain and update item listings that can be accessible in a delivery application managed by the central server computer 802. The delivery application can be installed on end user devices and can allow end users to select items from the item listings to have delivered to the end user from a service provider location by a transporter. The central server computer 802 can update item listings based on item information data entries in the item information database 110.

In some embodiments, the central server computer 802 can maintain and update item listings on the delivery application using modified machine readable codes from the item information database 110 as well as inventory information provided from the service provider computer 822. For example, the item information database 110 can indicate that a particular item has been identified using a modified machine readable code from an image captured at the service provider location. The central server computer 802 can update the item listing for the particular item based on the information from the item information database 210.

The logistics platform 804 can include a location determination system, which can determine the locations of various user devices such as transporter user devices (e.g., the transporter user device 814) and end user devices (e.g., the end user device 806). The logistics platform 804 can also include routing logic to efficiently route transporters using the transport user devices to various pickup locations that have the packages that are to be delivered to drop-off locations. Efficient routes can be determined based on the locations of the transporters, the locations of the pickup locations, the locations of the drop-off locations, as well as external data such as traffic patterns, the weather, etc. The logistics platform 804 can be part of the central server computer 802 or can be a system that is separate from the central server computer 802.

The end user device 806 can include a device operated by the end user 808. The end user devices 806 can generate and provide fulfillment request messages to the central server computer 802. The fulfillment request message can indicate that the request (e.g., a request for a service) can be fulfilled by the service provider computer 822. For example, the fulfillment request message can be generated based on a cart selected at checkout during a transaction using a central server computer application installed on the end user device 806. The fulfillment request message can include one or more items from the selected cart.

The end user device 806 can provide a fulfillment request message to the central server computer 802 that indicates that the end user device 806 is requesting that the transporter 816 pickup an item from the pickup location 810 (e.g., end user's 808 location) and deliver the item to the drop-off location 812 (e.g., the service provider computer's 822 location).

The pickup location 810 can be a location in which items are stored. In the context of an outbound delivery from an end user at an end user location, examples of the pickup location 810 may be a house or an apartment, a mailbox, a service provider location (e.g., a retail store, a grocery store, a dry cleaning store), a pickup hub, etc. Items can first be obtained from a pickup location 810 and then be transported to the drop-off location 812. Examples of the drop-off location 812 can be similar to the pickup location 810, such as a house or apartment, a mailbox, a retail store, a grocery store, a dry cleaning store, a pickup hub, etc. In one example, the pickup location 810 can be a pizza parlor from which the end user 808 orders a pizza. The drop-off location 812 can be an apartment in which the end user 808 resides.

The transporter user device 814 can include a device operated by the transporter 816. The transporter user device 814 can include a smartphone, a wearable device, a personal assistant device, etc. The transporter 816 can accept an end user's fulfillment request via an acceptance message. For example, the transporter user device 814 can generate and transmit a request to fulfill a particular end user's fulfillment request to the central server computer 802. The central server computer 802 can notify the transporter user device 814 of the fulfillment request. The transporter user device 814 can respond to the central server computer 802 with a request to perform the delivery to the end user as indicated by the fulfillment request.

In some embodiments, the transporter 816 can be an operator of a vehicle. In other embodiments, the transporter 816 can be a vehicle that can be operated by an operator or can be autonomous. The vehicle can include a car, a truck, a van, a motorcycle, a bicycle, a drone, or other vehicle.

The navigation network 820 can provide navigational directions to the transporter user device 814. For example, the transporter user device 814 can obtain a location from the central server computer 802. The location can be a service provider parking location, a service provider location, an end user parking location, an end user location, etc. The navigation network 820 can provide navigational data to the location. For example, the navigation network 820 can be a global positioning system that provides location data to the transporter user device 814.

The service provider computer 822 include computers operated by a service provider. For example, the service provider computer 822 can be a food provider computer that is operated by a food provider. The service provider computer 822 can offer to provide services to the end user 808 of the end user device 806. In embodiments of the invention, the service provider computer 822 can receive requests to prepare one or more items for delivery from the central server computer 802. The service provider computer 822 can initiate the preparation of the one or more items that are to be delivered to the end user 808 of the end user device 806 by the transporter 816 of the transporter user device 814.

Embodiments of the disclosure have a number of advantages. Prior systems were slow to perform and slow to update. Embodiments of invention can identify items with greater accuracy, speed, and timeliness than conventional processes. For example, by analyzing images of shelves with shelf tags and items, a user need not scan barcodes one by one to determine the inventory of items at a service provider. Also, such images can be taken by employees of the service provider, machines, or others not employed to the service provider making it easy to obtain such data. The data can be analyzed in near real time and adjustments to planograms, item quantity indicators, and ordering systems can also be made in near real time.

Although the steps in the flowcharts and process flows described above are illustrated or described in a specific order, it is understood that embodiments of the invention may include methods that have the steps in different orders. In addition, steps may be omitted or added and may still be within embodiments of the invention.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

As used herein, the use of “a,” “an,” or “the” is intended to mean “at least one,” unless specifically indicated to the contrary.

What is claimed is:

1. A method comprising:
receiving, by a computer, image data of an image of a shelf unit with a plurality of items and a plurality of item tags comprising machine readable codes adjacent to the items;
performing, by the computer a multi-modal item identification process to identify an item associated with an item tag of the plurality of item tags using the multi-modal item identification process; and
performing, by the computer, additional processing with respect to the identified item.

2. The method of claim 1, wherein the multi-modal item identification process comprises two or more of:
a first process of decoding a machine readable code on the item tag corresponding to the item to identify the item;
a second process of performing an optical character recognition process on text on the item tag corresponding to the item to identify the item;
a third process of performing an optical character recognition process on text on the item to identify the item;
a fourth process performing a computer vision identification process on the item to identify the item; and
a fifth process of using historical data associated with a location of the item on the shelf unit to identify the item.

3. The method of claim 2, wherein the historical data is obtained from a planogram.

4. The method of claim 1, wherein the multi-modal item identification process comprises all of:
a first process of decoding a machine readable code on the item tag corresponding to the item to identify the item;
a second process of performing an optical character recognition process on text on the item tag corresponding to the item to identify the item;
a third process of performing an optical character recognition process on text on the item to identify the item;
a fourth process performing a computer vision identification process on the item to identify the item; and
a fifth process of using historical data associated with a location of the item on the shelf unit to identify the item.

5. The method of claim 4, wherein the multi-modal item identification process further comprises weighting results of the first, second, third, fourth, and fifth processes, and identifying the item based on the weighted first, second, third, fourth, and fifth processes.

6. The method of claim 1, wherein the image is obtained from a user device that takes a picture of the shelf unit, the user device being operated by a user.

7. The method of claim 6, further comprising:
providing, by the computer, an instruction to the user device, wherein the instruction instructs the user to proceed to a location in an aisle defined by the shelf unit.

8. The method of claim 7, where the user is a transporter that delivers the item to an end user.

9. The method of claim 1, wherein the item is a food item, and the shelf unit is a shelf in a grocery store.

10. The method of claim 1, wherein additional processing comprises:
updating a planogram to include the item.

11. The method of claim 1, wherein the item is not on the shelf unit.

12. The method of claim 1, wherein the item on the shelf unit.

13. The method of claim 1, wherein performing additional processing comprises automatically updating a planogram to include identification of the item.

14. The method of claim 1, wherein performing additional processing comprises automatically adjusting an availability indicator for the item.

15. The method of claim 1, further comprising:
performing the multi-modal item identification process to identify all items associated with all tags in the image.

16. The method of claim 1, further comprising:
receiving, by the computer from a user device, a plurality of images of multiple shelf units in a service provider location, each of the images in the plurality of images comprising item tags associated with items;
performing, by the computer, the multi-modal item identification process for all item tags in all images to identify items associated with the item tags; and
performing, by the computer, further additional processing based on the identified items.

17. The method of claim 1, multiple shelf units form multiple aisles at a service provider location, and the multiple aisles are all aisles at the service provider location.

18. A computer comprising:
a processor;
and a non-transitory computer readable medium comprising, code executable by the processor to cause the computer to perform operations comprising:
receiving, by the computer, image data of an image of a shelf unit with a plurality of items and a plurality of item tags comprising machine readable codes adjacent to the items;
performing, by the computer a multi-modal item identification process to identify an item associated with an item tag of the plurality of item tags using the multi-modal item identification process; and
performing, by the computer, additional processing with respect to the identified item.

19. The computer of claim 18, wherein the multi-modal item identification process comprises two or more of:
a first process of decoding a machine readable code on the item tag corresponding to the item to identify the item;
a second process of performing an optical character recognition process on text on the item tag corresponding to the item to identify the item;
a third process of performing an optical character recognition process on text on the item to identify the item;
a fourth process performing a computer vision identification process on the item to identify the item; and
a fifth process of using historical data associated with a location of the item on the shelf unit to identify the item.

20. The computer of claim 19, wherein the computer is a server computer, and wherein the historical data is obtained from a planogram.
